(19) United States
(12) Patent Application Publication
(10) Pub. No.: US 2019/0103064 A1
(43) Pub. Date: Apr. 4, 2019

(54) TRANSPARENT DISPLAY PANEL AND TRANSPARENT DISPLAY DEVICE

(71) Applicant: Limin WANG, Shenzhen, Guangdong (CN)

(72) Inventor: Limin WANG, Shenzhen, Guangdong (CN)

(73) Assignee: Shenzhen China Star Optoelectronics Technology Co., Ltd., Shenzhen, Guangdong (CN)

(21) Appl. No.: 15/545,694

(22) PCT Filed: Jun. 23, 2017
(86) PCT No.: PCT/CN2017/089680

§ 371 Date: Jul. 22, 2017

(30) Foreign Application Priority Data
May 25, 2017 (CN) 201710379297.0

(51) Int. Cl. G09G 3/36; G02F 1/1335; G02F 1/1343

(52) U.S. Cl. CPC G09G 3/3607; G02F 1/133528; G02F 1/133514; G02F 2201/123; G02F 1/134309; G02F 2201/121; G02F 1/133602

(57) ABSTRACT

A transparent display panel and device are disclosed. The transparent display panel includes a first substrate, a second substrate and a liquid crystal layer disposed there between. Each pixel structure includes a display region and a transparent region which are disposed adjacently. The display region includes a first switching transistor and a first electrode. The transparent region includes a second electrode, and the second electrode is coupled and connected with the first electrode. Accordingly, when the transparent display panel displays a high grayscale level, an affection of the display effect by the transmission light of the transparent region is reduced, and when displays a low grayscale level, the feature of transparent display can be achieved.

### BACKGROUND OF THE INVENTION

### 1. Field of the Invention

The present invention relates to a display technology field, and more particularly to a transparent display panel and transparent display device.

### 2. Description of Related Art

The transparent display device is a new application and appeared recently so that transparent display device is greatly concerned by people. The transparent display technology adopted in the transparent display device greatly expands application fields and ranges of the display technology such that the transparent display device provides convenience for people's live.

In the conventional art, an alignment film a traditional transparent display in a display region and in a transparent region are different such that when a voltage is not applied on the display device, a transparent status is displayed in order to decrease the power consumption. In a display status, an electrode in the transparent region of each pixel is applied with a voltage such that the transparent region becomes dark in order to decrease interference to the display by the transmission light.

However, in the conventional art, the electrode in the transparent region is designed to have an entire surface, and voltages on the electrodes in transparent regions of the pixels are shared with each other. When the electrode in the transparent region is applied with a high voltage, the transparent display device will totally loss a feature of the transparent display so that the display quality cannot be ensured and the display feature of the transparent display cannot be achieved at the same time.

### SUMMARY OF THE INVENTION

The present invention provides a transparent display panel and transparent display device. When the transparent display panel displays a high grayscale level, an affection of the display effect by the transmission light of the transparent region is reduced, and when displays a low grayscale level, the feature of transparent display can be achieved

In order to solve the above technology problem, a technology solution adopted by the present invention is: providing a transparent display panel, comprising: a first substrate; a second substrate; and a liquid crystal layer disposed between the first substrate and the second substrate; wherein, the first substrate or the second substrate includes multiple pixel structures arranged as a matrix, and each pixel structure includes a display region and a transparent region which are disposed adjacently; wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode; wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line; wherein, the first electrode and the second electrode are connected directly; and wherein, the transparent display panel includes a color filter film.

In order to solve the above technology problem, another technology solution adopted by the present invention is: providing a transparent display panel, comprising: a first substrate; a second substrate; and a liquid crystal layer disposed between the first substrate and the second substrate; wherein, the first substrate or the second substrate includes multiple pixel structures arranged as a matrix, and each pixel structure includes a display region and a transparent region which are disposed adjacently; wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode; and wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line.

In order to solve the above technology problem, another technology solution adopted by the present invention is: a transparent display device, comprising: a backlight system; and a transparent display panel including: a first substrate; a second substrate; and a liquid crystal layer disposed between the first substrate and the second substrate; wherein, the first substrate or the second substrate includes multiple pixel structures arranged as a matrix, and each pixel structure includes a display region and a transparent region which are disposed adjacently; wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode; and wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line.

The beneficial effect of the present invention is: comparing to the conventional art, in the present invention, through coupling and connecting the first electrode in the display region with the second electrode in the transparent region, and through the data control signal to simultaneously control the deflection of the liquid crystal molecules in the display region and the transparent region, when the transparent display panel displays a high grayscale level, an affection of the display effect by the transmission light of the transparent region is reduced, and when displays a low grayscale level, the feature of transparent display can be achieved.

### BRIEF DESCRIPTION OF THE DRAWINGS

FIG. 1 is a schematic structure diagram of a transparent display panel according to an embodiment of the present invention;

FIG. 2 is a schematic structure diagram of a pixel structure according to an embodiment of the present invention;

FIG. 3 is a schematic diagram of a display effect of the transparent display panel according to an embodiment of the present invention;

FIG. 4 is a schematic structure diagram of a transparent display panel according to another embodiment of the present invention; and

FIG. 5 is a schematic structure diagram of a transparent display device according to an embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention

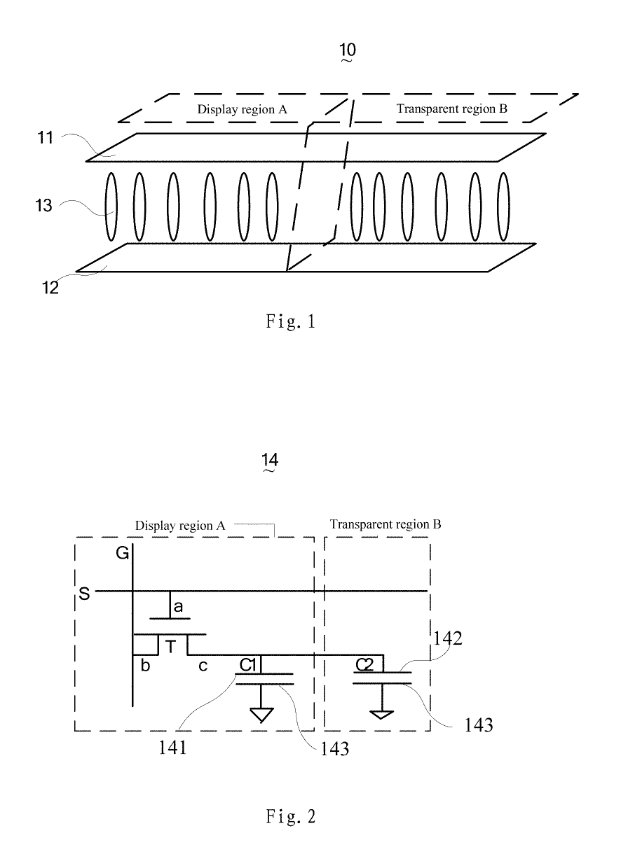

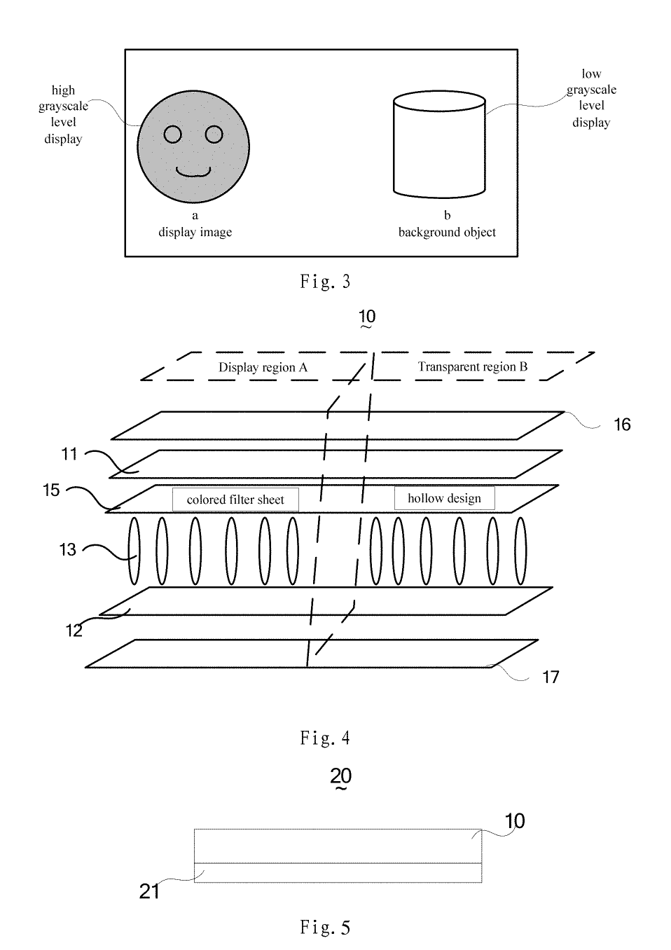

With reference to FIG. 1, FIG. 2 and FIG. 3, FIG. 1 is a schematic structure diagram of a transparent display panel according to an embodiment of the present invention, FIG. 2 is a schematic structure diagram of a pixel structure according to an embodiment of the present invention, and FIG. 3 is a schematic diagram of a display effect of the transparent display panel according to an embodiment of the present invention. As shown in FIG. 1, the transparent display panel 10 includes: a first substrate 11, a second substrate 12 and liquid crystal layer 13 clamped between the first substrate 11 and the second substrate 12.

With reference to FIG. 2, the first substrate 11 or the second substrate 12 includes multiple pixel structures 14 arranged as a matrix. Each pixel structure includes a display region A and a transparent region B disposed adjacently.

For each pixel structure 14, the display region A includes: a first switching transistor T and a first electrode 141. Wherein, a control terminal “a” of the first switching transistor T is connected with a scanning line S, a first terminal “b” of the first switching transistor T is connected with a data line G, a second terminal “c” of the first switching transistor T is connected with the first electrode 141.

The transparent region B includes: a second electrode 142, wherein the second electrode 142 is coupled and connected with the first electrode 141, and when the first switching transistor T is turned on, controlling the deflection of the liquid crystal molecules 13 in the transparent region B through a data control signal applied on the data line G. Wherein, the first electrode 141 and the second electrode 142 in the display region A and the transparent region B can be a same electrode or different electrode, and the present invention is not limited. In a specific embodiment, the first electrode 141 in the display region A, the common electrode 143 and the liquid crystal layer 13 clamped between the first electrode 141 and the common electrode 143 form a first liquid crystal capacitor C1. The second electrode 142 in the transparent region B, the common electrode 143 and the liquid crystal layer 13 clamped between the second electrode 142 and the common electrode 143 form a second liquid crystal capacitor C2.

In one application field of the present invention, the first electrode 141 in the display region A and the second electrode 142 in the transparent region B are connected directly. When the pixel structure 14 is not applied with a voltage, the liquid crystal molecules 13 in the transparent region B is not deflected, that is, the transparent region B does not shade the light so as to have a transparent display effect. When a high voltage level is applied on the scanning line S, the first switching transistor T is turned on, and a data voltage applied on the data line G to simultaneously control the liquid crystal molecules 13 in the display region A and the transparent region B to deflect.

Wherein, when a high data voltage is inputted, a deflection degree of the liquid crystal molecules 13 in the transparent region B is greater, the transparent region B shade light in order to reduce an affection of the transmission light to the display effect. When a low data voltage is inputted, a deflection degree of the liquid crystal molecules 13 in the transparent region B is less or no deflection is generated, the transparent display region B still has a transparent display effect. Specifically, with reference to FIG. 3, wherein FIG. 3a shows an image in a high grayscale level normal display and when the transparent region B shades a light. FIG. 3b shows an image that a background object can be seen in a low grayscale level display and when the transparent region B is transparent.

In the above embodiment, through coupling and connecting the first electrode in the display region with the second electrode in the transparent region, and through the data control signal to simultaneously control the deflection of the liquid crystal molecules in the display region and the transparent region, when the transparent display panel displays a high grayscale level, an affection of the display effect by the transmission light of the transparent region is reduced, and when displays a low grayscale level, the feature of transparent display can be achieved.

With reference to FIG. 4, FIG. 4 is a schematic structure diagram of a transparent display panel according to another embodiment of the present invention. As shown in FIG. 4, the transparent display panel 10 includes a color filter film 15 disposed between the liquid crystal layer 13 and the first substrate 11 or disposed between the liquid crystal layer 13 and the second substrate 12. Wherein, if the first substrate 11 is an array substrate, the second substrate is a color filter substrate, and the color filter film 15 is disposed on the second substrate 12. Of course, in another embodiment, the first substrate 11 can be a color filter substrate, and the second substrate 12 can be an array substrate. In the present embodiment, the color filter film 15 can be disposed on the first substrate 11. Here, the words “the first” and “the second” are only used for describing, and cannot be understood as an instruction or a hint for a relative importance or an instruction for the number of the technical feature.

In the display region A, the color filter film 15 is disposed as a non-transparent and colored filter sheet, and specifically can be a red, a green or a blue color filter sheet. The color filter film 15 can filter a white light passing through the liquid crystal layer 13 to a required red, green or blue light. In the transparent region B, the color filter film 15 is a hollow design. That is, no color filter film is added. When displaying, and when a white light emitted from a light source pass through the hollow design, the white light is not filtered. That is, an emitted light is still a white light. Besides, the display panel 10 further includes a first polarizer 16 and a second polarizer 17 respectively disposed at two sides of the transparent display panel 10. Wherein, the function of the first polarizer 16 and the second polarizer 17 is to polarize a nature light (white light) which does not has a polarization characteristic into a polarized light. With the deflection feature of the liquid crystal molecules 13, the penetration of a light is controlled in order to realize a normal image display to increase the transmittance and viewing angle.

With reference to FIG. 5, FIG. 5 is a schematic structure diagram of a transparent display device according to an embodiment of the present invention. As shown in FIG. 5, the transparent display device 20 includes a backlight system 21 and a transparent display panel 10.

Wherein, the specific description of the transparent display panel 10 can refer to FIG. 1 and FIG. 2. Specifically, the transparent display panel 10 includes: a first substrate 11, a second substrate 12 and liquid crystal layer 13 clamped between the first substrate 11 and the second substrate 12.

The first substrate 11 or the second substrate 12 includes multiple pixel structures 14 arranged as a matrix. Each pixel structure includes a display region A and a transparent region B disposed adjacently. For each pixel structure 14, the display region A includes: a first switching transistor T and a first electrode 141. Wherein, a control terminal “a” of the first switching transistor T is connected with a scanning line S, a first terminal “b” of the first switching transistor T is connected with a data line G, a second terminal “c” of the first switching transistor T is connected with the first electrode 141.

The transparent region B includes: a second electrode 142, wherein the second electrode 142 is coupled and connected with the first electrode 141, and when the first switching transistor T is turned on, controlling the deflection of the liquid crystal molecules 13 in the transparent region B through a data control signal applied on the data line G. Wherein, the first electrode 141 and the second electrode 142 in the display region A and the transparent region B can be a same electrode or different electrode, and the present invention is not limited. In a specific embodiment, the first electrode 141 in the display region A, the common electrode 143 and the liquid crystal layer 13 clamped between the first electrode 141 and the common electrode 143 form a first liquid crystal capacitor C1. The second electrode 142 in the transparent region B, the common electrode 143 and the liquid crystal layer 13 clamped between the second electrode 142 and the common electrode 143 form a second liquid crystal capacitor C2.

The transparent display panel 10 includes a color filter film 15 disposed between the liquid crystal layer 13 and the first substrate 11 or disposed between the liquid crystal layer 13 and the second substrate 12. Wherein, if the first substrate 11 is an array substrate, the second substrate is a color filter substrate, and the color filter film 15 is disposed on the second substrate 12. Of course, in another embodiment, the first substrate 11 can be a color filter substrate, and the second substrate 12 can be an array substrate.

In the display region A, the color filter film 15 is disposed as a non-transparent and colored filter film, and specifically can be a red, a green or a blue color filter film. The color filter film 15 can filter a white light passing through the liquid crystal layer 13 to a required red, green or blue light. In the transparent region B, the color filter film 15 is a hollow design. That is, no color filter film is added. When displaying, and when a white light emitted from the backlight system 21 pass through the hollow design, the white light is not filtered. That is, an emitted light is still a white light. Besides, the display panel 10 further includes a first polarizer 16 and a second polarizer 17 respectively disposed at two sides of the transparent display panel 10. Wherein, the function of the first polarizer 16 and the second polarizer 17 is to polarize a nature light (white light) which does not has a polarization characteristic into a polarized light. With the deflection feature of the liquid crystal molecules 13, the penetration of a light is controlled in order to realize a normal image display to increase the transmittance and viewing angle.

In the above embodiment, through coupling and connecting the first electrode in the display region with the second electrode in the transparent region, and through the data control signal to simultaneously control the deflection of the liquid crystal molecules in the display region and the transparent region, when the transparent display panel displays a high grayscale level, an affection of the display effect by the transmission light of the transparent region is reduced, and when displays a low grayscale level, the feature of transparent display can be achieved.

In summary, person skilled in the art can understood that, the present invention provides a transparent display panel and device, through coupling and connecting the first electrode in the display region with the second electrode in the transparent region, and through the data control signal to simultaneously control the deflection of the liquid crystal molecules in the display region and the transparent region, when the transparent display panel displays a high grayscale level, an affection of the display effect by the transmission light of the transparent region is reduced, and when displays a low grayscale level, the feature of transparent display can be achieved.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A transparent display panel, comprising:
a first substrate;
a second substrate; and
a liquid crystal layer disposed between the first substrate and the second substrate;
wherein, the first substrate or the second substrate includes multiple pixel structures arranged as a matrix, and each pixel structure includes a display region and a transparent region which are disposed adjacently;
wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode;
wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line;
wherein, the first electrode and the second electrode are connected directly; and
wherein, the transparent display panel includes a color filter film.

2. The transparent display panel according to claim 1, wherein, in the display region, the color filter film is disposed as a non-transparent and colored filter sheet, and in the transparent region, the color filter film is a hollow disposition.

3. The transparent display panel according to claim 1, wherein, the transparent display panel further includes a first polarizer and a second polarizer respectively disposed at two sides of the transparent display panel.

4. A transparent display panel, comprising:
a first substrate;
a second substrate; and
a liquid crystal layer disposed between the first substrate and the second substrate;
wherein, the first substrate or the second substrate includes multiple pixel structures arranged as a matrix, and each pixel structure includes a display region and a transparent region which are disposed adjacently;
wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode; and
wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line.

5. The transparent display panel according to claim 4, wherein, the first electrode and the second electrode are connected directly.

6. The transparent display panel according to claim 4, wherein, the transparent display panel includes a color filter film.

7. The transparent display panel according to claim 6, wherein, in the display region, the color filter film is disposed as a non-transparent and colored filter sheet, and in the transparent region, the color filter film is a hollow disposition.

8. The transparent display panel according to claim 4, wherein, the transparent display panel further includes a first polarizer and a second polarizer respectively disposed at two sides of the transparent display panel.

9. A transparent display device, comprising:
a backlight system; and
a transparent display panel including:
a first substrate;
a second substrate; and
a liquid crystal layer disposed between the first substrate and the second substrate;
wherein, the first substrate or the second substrate includes multiple pixel structures arranged as a matrix, and each pixel structure includes a display region and a transparent region which are disposed adjacently;
wherein, the display region includes a first switching transistor and a first electrode; a control terminal of the first switching transistor is connected with a scanning line, a first terminal of the first switching transistor is connected with a data line, and a second terminal of the first switching transistor is connected with the first electrode; and
wherein, the transparent region includes a second electrode, and the second electrode is coupled and connected with the first electrode; when the first switching transistor is turned on, controlling the deflection of liquid crystal molecules of the liquid crystal layer in the transparent region through a data control signal applied on the data line.

10. The transparent display device according to claim 9, wherein, the first electrode and the second electrode are connected directly.

11. The transparent display device according to claim 9, wherein, the transparent display panel includes a color filter film.

12. The transparent display device according to claim 11, wherein, in the display region, the color filter film is disposed as a non-transparent and colored filter sheet, and in the transparent region, the color filter film is a hollow disposition.

13. The transparent display device according to claim 9, wherein, the transparent display panel further includes a first polarizer and a second polarizer respectively disposed at two sides of the transparent display panel.
